(19) United States
(12) Patent Application Publication
(10) Pub. No.: US 2009/0242544 A1
(43) Pub. Date: Oct. 1, 2009

(54) WAFER HEATING APPARATUS HAVING ELECTROSTATIC ATTRACTION FUNCTION

(75) Inventor: Shoji Kano, Gunma (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 12/064,338

(22) PCT Filed: Oct. 10, 2006
(86) PCT No.: PCT/JP2006/320198

§ 371 Date: Feb. 21, 2008

(30) Foreign Application Priority Data
Oct. 12, 2005 (JP) 2005-297555

(51) Int. Cl. H05B 3/68

(52) U.S. Cl. 219/444.1

(57) ABSTRACT

In a wafer heating apparatus having an electrostatic attraction function, a conductive heat generating layer is formed on one plane of a supporting substrate, and a conductive electrode for electrostatic attraction is formed on the other plane, and furthermore, an insulating layer is formed to cover the heat generating layer and the electrode for electrostatic attraction. The wafer heating apparatus has the electrostatic attraction function characterized in that the insulating layer covering the electrode for electrostatic attraction has a lower surface resistivity (ρsE) in a portion on the side of an object to be attracted compared with a surface resistivity (ρsE) in a portion on the side of the electrostatic attraction electrode.

### TECHNICAL FIELD

This invention relates, in a process for manufacturing or inspecting semiconductor devices including a heating step, to a wafer heating apparatus having an electrostatic attraction function suited for use in the step of heating semiconductor wafers.

### BACKGROUND ART

In the process of manufacturing semiconductor devices, metal wire wound heaters are traditionally used to heat semiconductor wafers. The heaters of this type, however, give rise to a problem of metal contamination to semiconductor wafers. It was recently proposed to use ceramic monolithic wafer heaters having a ceramic thin film serving as a heating element as disclosed in JP-A 4-124076.

For heating wafers during molecular beam epitaxy, CVD, sputtering and similar processes, it is regarded effective to use a composite ceramic heater of pyrolytic boron nitride (PBN) and pyrolytic graphite (PG) which produces no outgassing from within the support substrate and has high purity and thermal shock resistance as disclosed in JP-A 63-241921. As compared with prior art tantalum wire heaters, the composite ceramic heater has many advantages including easy mounting and easy use because troubles like thermal deformation, breaks and short-circuits are avoidable. In addition, it is a film heater so that a relatively uniform heat distribution is achievable.

When a semiconductor wafer is to be heated, an electrostatic chuck apparatus is used in a low pressure atmosphere for holding the semiconductor wafer on the heater. As the process temperature elevated, the material of the apparatus changed from resins to ceramics. See JP-A 52-67353 and JP-A 59-124140.

One recent proposal is a wafer heating apparatus having an electrostatic attraction function constructed by combining a ceramic monolithic wafer heater with an electrostatic chuck. For example, an apparatus using alumina in the insulating layer of the electrostatic chuck (as disclosed in New Ceramics, 7, pp. 49-53, 1994) is used in the low-temperature range as encountered in the etching step or the like. Another apparatus using pyrolytic boron nitride in the insulating layer of the electrostatic chuck (as disclosed in JP-A 4-358074, JP-A 5-109876, and JP-A 5-129210) is used in the high-temperature range as encountered in the CVD step or the like.

The electrostatic attraction force becomes stronger as the volume resistivity of the insulating layer becomes lower, as described in New Ceramics, 7, pp. 49-53, 1994. Too low a volume resistivity can cause a device failure due to current leakage. It is then believed desirable that the insulating layer of the electrostatic chuck apparatus has a volume resistivity of 10⁸ to 10¹⁸ Ω/cm, and preferably 10⁹ to 10¹³ Ω/cm.

The electrostatic chucks are classified into three types, depending on the shape of the electrode to which voltage is applied. In chucks of the monopolar type having a single internal electrode, the workpiece should be grounded. By contrast, in chucks of the bipolar type having a pair of internal electrodes and chucks of the comb-shaped electrode type having a pair of comb-shaped electrodes, the workpiece or wafer need not be grounded because positive and negative voltages are applied to the paired electrodes. Chucks of the latter types are often used in the semiconductor application.

In the modern molecular beam epitaxy, CVD, and sputtering systems, ceramic electrostatic chuck apparatus are mounted. The semiconductor device manufacturing process poses an increasing demand for service at elevated temperatures beyond 500° C.

Where alumina is used in the insulating layer of the wafer heating apparatus having an electrostatic attraction function, the insulating layer has too low a resistivity in the moderate to high temperature range from 500° C. to 650° C., giving rise to a problem that devices fail due to current leakage. Instead, where pyrolytic boron nitride is used, the insulating layer has too high a resistivity in the moderate to high temperature range, giving rise to a problem that a sufficient electrostatic attraction force is unavailable.

To overcome these problems, JP-A 9-278527 proposes an electrostatic chuck apparatus comprising an insulating layer formed of pyrolytic boron nitride containing 1-20 wt % of carbon, and JP-A 8-227933 proposes an electrostatic chuck apparatus comprising an insulating layer formed of pyrolytic boron nitride containing 1-10 wt % of silicon. Then the insulating layer has an appropriate resistivity in the moderate to high temperature range from 500° C. to 650° C., to produce a sufficient electrostatic attraction force.

However, the function of the electrostatic chuck apparatus requires to apply a high voltage in order to attract and chuck a wafer thereto. Owing to the electric charge accumulated in the insulating layer, a residual attraction force is exerted even after the power supply is turned off, giving rise to a problem that the wafer is misregistered upon removal from the chuck, causing an interference to automatic transfer. As the service range becomes higher temperature, more leakage current flows between a pair of electrodes in the bipolar arrangement and at the worst, there arises a problem that the insulating layer undergoes breakdown, losing the attraction function. If the insulating layer undergoes breakdown, this electrostatic chuck apparatus must be replaced. The replacement interrupts the semiconductor device manufacturing process, leading to an increased cost. Therefore, there is a desire to have an electrostatic chuck apparatus which provides stable performance over a long lifetime even in the high temperature range.

### DISCLOSURE OF THE INVENTION

### Problem to be Solved by the Invention

An object of the invention is to provide a wafer heating apparatus having an electrostatic attraction function which is used in heating wafers in the electrostatically chucked state and which produces a sufficient electrostatic attraction force even at high temperatures without the risk of breakdown, and is devoid of a residual force to attract workpieces (or wafers).

### Means for Solving the Problems

Making extensive investigations to attain the above object, the inventor has found that in a wafer heating apparatus having a function of electrostatically attracting a workpiece, comprising a conductive heating layer formed on one surface of a support substrate, a conductive electrode for electrostatic attraction formed on another surface of the support substrate, and an insulating layer formed to cover the heating layer and the electrode for electrostatic attraction, the problem can be solved by modifying the surface resistivity of the insulating layer covering the electrode as follows. Specifically, provided that the insulating layer covering the electrode includes a region adjoining the electrode and another region adjoining the workpiece, when the workpiece-adjoining region has a surface resistivity (ρsS) which is lower than the surface resistivity (ρsE) of the electrode-adjoining region, no residual attraction force is exerted after turning off the applied voltage, the electric charge accumulated in the insulating layer is prone to escape, and the misregistration of wafers upon removal is avoided. Moreover, when a ratio (ρsE/ρsS) of the surface resistivity (ρsE) of the electrode-adjoining region to the surface resistivity (ρsS) of the workpiece-adjoining region is up to 100, and when ρsE and ρsS are each at least 1×10⁸ Ω/square, the apparatus produces a sufficient electrostatic attraction force in a stable manner over a long period of time at room temperature to the moderate to high temperature range of 500 to 650° C. without the risk of breakdown between bipolar electrodes. The present invention is predicated on these findings.

Accordingly, the present invention provides:

(1) a wafer heating apparatus having a function of electrostatically attracting a workpiece, comprising a conductive heating layer formed on one surface of a support substrate, a conductive electrode for electrostatic attraction formed on another surface of the support substrate, and an insulating layer formed to cover the heating layer and the electrode for electrostatic attraction, characterized in that said insulating layer covering the electrode includes a region adjoining the electrode and another region disposed to adjoin the workpiece, and the workpiece-adjoining region has a surface resistivity (ρsS) lower than the surface resistivity (ρsE) of the electrode-adjoining region; and
(2) a wafer heating apparatus having a function of electrostatically attracting a workpiece, comprising a conductive heating layer formed on one surface of a support substrate, a conductive electrode for electrostatic attraction formed on another surface of the support substrate, and an insulating layer formed to cover the heating layer and the electrode for electrostatic attraction, characterized in that said insulating layer covering the electrode includes a region adjoining the electrode and another region disposed to adjoin the workpiece, that a ratio (ρsE/ρsS) of a surface resistivity (ρsE) of the electrode-adjoining region to a surface resistivity (ρsS) of the workpiece-adjoining region is up to 100, and that the surface resistivities (ρsE and ρsS) are each at least 1×10⁸ ohm/square (Ω/□).

### BENEFITS OF THE INVENTION

The wafer heating apparatus having an electrostatic attraction function according to the invention produces a sufficient electrostatic attraction force in a stable manner over a long period of time at room temperature to the moderate to high temperature range of 500 to 650° C. without the risk of breakdown between bipolar electrodes. It overcomes problems including a lowering of manufacturing capability by replacement operation taken upon breakdown of the insulating layer, wafer separation during the device manufacture due to shortage of attraction force, the development of an uneven temperature distribution due to shortage of attraction force, and misregistration of wafers due to residual attraction following interruption of the applied voltage.

### BRIEF DESCRIPTION OF THE DRAWINGS

FIG. 1 is a cross-sectional view of a heating apparatus according to one embodiment of the invention.

FIG. 2 is an enlarged cross-sectional view of a portion of the same embodiment.

FIG. 3 illustrates how to measure the electrostatic attraction force of heating apparatus in Example and Comparative Example.

FIG. 4 is a graph showing the electrostatic attraction force versus ρsE and ρsS of heating apparatus in Example and Comparative Example.

### BEST MODE FOR CARRYING OUT THE INVENTION

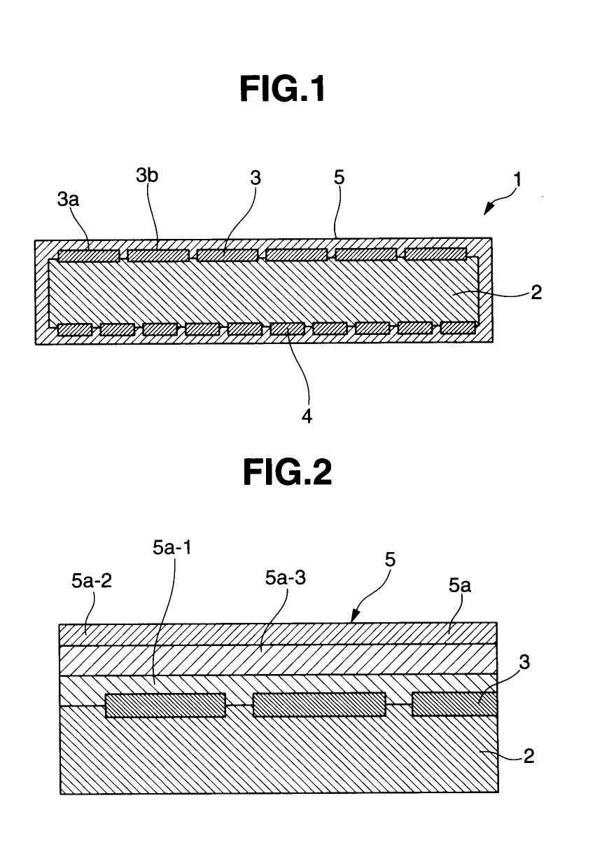

Referring to FIG. 1, a wafer heating apparatus 1 having an electrostatic attraction function according to the invention is illustrated as comprising a support substrate 2, a conductive heating layer 4 formed on one surface of support substrate 2, a conductive electrode 3 for electrostatic attraction formed on another surface of support substrate 2, and an insulating layer 5 formed to cover heating layer 4 and electrode 3 for electrostatic attraction.

In the embodiment, the support substrate is preferably made of a material comprising a main component selected from among sintered silicon nitride, sintered boron nitride, a sintered mixture of boron nitride and aluminum nitride, sintered alumina, sintered aluminum nitride, pyrolytic boron nitride, and pyrolytic boron nitride-coated graphite. Such a material is desired because its physical properties remain stable even in the moderate to high temperature range of 500 to 650° C. As used herein, the term “main component” means that the material contains at least 80% by weight, and especially at least 90% by weight of the component, with the balance consisting of sintering aids.

Also, the conductive heating layer may be formed of SiC, graphite (C), Mo, Ti or material having a volume resistivity of not more than 1×10⁵ Ω-cm. The layer may be formed by patterning the material to an appropriate shape.

The electrode for electrostatic attraction may be formed of SiC, graphite (C), Mo, Ti or material having a volume resistivity of not more than 1×10⁵ Ω-cm. The electrode may also be formed by patterning the material to an appropriate shape. It is preferred that the electrode for electrostatic attraction have a bipolar structure having a pair of electrodes, the bipolar electrodes being alternately arranged in a comb-shaped or concentric fashion. The thus configured electrodes facilitate to stabilize the attraction force within the wafer plane. It is noted that 3a and 3b in FIG. 1 denote bipolar electrodes for electrostatic attraction.

Further, the insulating layer is preferably formed of at least one component selected from among silicon nitride, boron nitride, aluminum nitride, alumina, a mixture of boron nitride and silicon nitride, a mixture of boron nitride and aluminum nitride, and yttria.

Also, preferably at least one, more preferably all of the electrode for electrostatic attraction, the heating layer, and the insulating layer are formed by chemical vapor deposition (CVD). Formation of layers by CVD ensures that a layer is formed to a desired uniform thickness, and prevents separation or particle generation.

In the wafer heating apparatus having an electrostatic attraction function arranged as above, according to the invention, insulating layer 5a covering electrode 3 includes a region 5a-1 disposed on the side of or adjoining the electrode and another region 5a-2 disposed on the side of or adjoining a workpiece to be chucked, as shown in FIG. 2, and workpiece-adjoining region 5a-2 has a lower surface resistivity (ρsS) than the surface resistivity (ρsE) of electrode-adjoining region 5a-1. This setting eliminates residual attraction of wafers immediately after turning off the applied voltage, allowing removal of heated workpieces. Moreover, when a ratio (ρsE/ρsS) of the surface resistivity (ρsE) of electrode-adjoining region 5a-1 to the surface resistivity (ρsS) of workpiece-adjoining region 5a-2 is up to 100, and when ρsE and ρsS are each at least 1×10⁸ Ω/square, the apparatus produces a sufficient electrostatic attraction force at room temperature to high temperature. It is noted in FIG. 2 that insulating layer 5a covering electrode 3 includes an intermediate region 5a-3.

It is contemplated herein that electrode-adjoining region 5a-1 is a region extending from the surface of electrode 3 inward of the insulating layer (toward the workpiece) to a distance of 50 μm, and workpiece-adjoining region 5a-2 is a region extending from the outer surface of insulating layer 5a inward of the insulating layer (toward the electrode) to a distance of 50 μm. Preferably, insulating layer 5a has a thickness of 100 to 300 μm, and more preferably 100 to 150 μm.

Also preferably, the insulating layer covering the heater has a thickness of 50 to 300 μm, and more preferably 80 to 200 μm.

According to the invention, the surface resistivity (ρsS) of workpiece-adjoining region 5a-2 is lower than the surface resistivity (ρsE) of electrode-adjoining region 5a-1. It is desired that ρsE and ρsS be each at least 1×10⁸ Ω/square, preferably 1×10⁸ Ω/square to 1×10¹⁴ Ω/square, more preferably 1×10⁹ Ω/square to 1×10¹⁴ Ω/square, and even more preferably 1×10¹⁰ Ω/square to 1×10¹⁴ Ω/square. It is also desired that ρsE/ρsS be from 1 to 100, and more preferably from 1 to 10. It is understood that intermediate region 5a-3 may have a resistivity of 2×10⁸ Ω/square to 9×10¹⁴ Ω/square, and preferably an intermediate value between ρsE and ρsS.

The feature of the invention is that the insulating layer covering the electrode for electrostatic attraction includes electrode and workpiece-adjoining regions having different values of surface resistivity. Means for changing surface resistivity may be accomplished, for example, by adding a resistivity modifier to the insulating layer and dispersing the modifier so as to provide it with anisotropy, or by applying heat so as to form an oriented crystalline film, or in the event the layer is formed by vapor phase growth, by changing the type and flow rate of reactant gases, reaction temperature, pressure and other parameters.

The region extending from the workpiece-adjoining region to the electrode-adjoining region preferably has a graded surface resistivity. An abrupt change of surface resistivity in the insulating layer would provide a boundary layer thereat so that the layer becomes weak from the structural standpoint.

As described above, the insulating layer is advantageously formed of at least one component selected from among sintered silicon nitride, sintered boron nitride, a sintered mixture of boron nitride and aluminum nitride, sintered alumina, sintered aluminum nitride, and pyrolytic boron nitride. Means for changing the surface resistivity of the insulating layer is preferably by incorporating a resistivity modifier in a range of 0.001% to 30% by weight, more preferably 0.01% to 25% by weight, and even more preferably 0.1 to 20% by weight for modifying surface resistivity. The insulating layer made of such a composition is desirable in that it maintains stable physical properties even in the moderate to high temperature range of 500 to 650° C., and also desirable in that it produces a satisfactory electrostatic attraction force.

The resistivity modifier is preferably at least one member selected from among boron, silicon, carbon, aluminum, yttrium, titanium, and boron carbide. When the modifier is any of these, the resistivity of the layer is determined by the amount of modifier, with the advantage of ease of resistivity modification.

### Example

Examples and Comparative Examples are given below for further illustrating the invention, but the invention is not limited thereto.

### Example 1 & Comparative Example 1

A mixture of ammonia and boron trichloride was reacted at 1,800° C. and 100 Torr to deposit a boron nitride film of 300 μm thick on a graphite substrate having a diameter of 200 mm and a thickness of 20 mm, yielding a pyrolytic boron nitride-coated graphite substrate.

Then methane gas was pyrolyzed at 2,200° C. and 5 Torr, depositing a pyrolytic graphite layer having a thickness of 100 μm and a volume resistivity of 0.4 mΩ-cm on the substrate.

The pyrolytic graphite layer on the top surface was patterned to form bipolar electrodes (for electrostatic attraction) alternately arranged in a concentric fashion whereas the pyrolytic graphite layer on the back surface was patterned into a heater. In this way, electrostatic attraction electrodes and a heating layer were formed.

On the opposed surfaces, a mixture of ammonia, boron trichloride, and methane was reacted at a varying temperature in the range of 1,900° C. to 2,000° C. and a varying pressure in the range of 1 to 100 Torr to deposit an insulating layer of carbon-containing pyrolytic boron nitride having a thickness of 200 μm and a surface resistivity varying in the depositing direction. Note that the insulating layer of carbon-containing pyrolytic boron nitride can be prepared according to the teachings of J. Appln. Phys., Vol. 65, 1989, and JP-A 9-278527.

Finally, the attraction surface was mirror polished, completing a wafer heating apparatus having an electrostatic attraction function.

For the samples obtained by varying the conditions under which the insulating layer was deposited, an attraction force was measured by applying a DC voltage of ±500 V between bipolar electrodes at 25° C. (room temperature), 300° C. or 650° C.

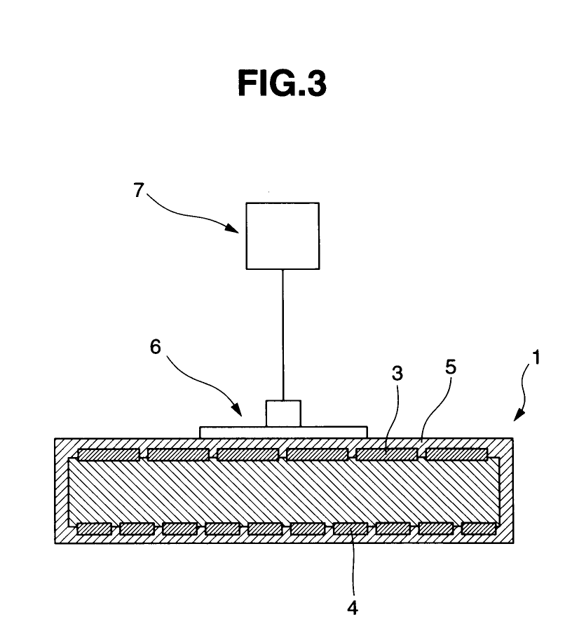

The measurement of an attraction force was carried out in vacuum (10 Pa), as shown in FIG. 3, by pulling up a silicon jig 6 attracted to the apparatus, and reading a value of a load cell 7 when the jig 6 was removed, the cell value being an attraction force. The measurement was carried out both during the application of a DC voltage of ±500 V and after 10 seconds from the interruption of the applied voltage. If an attraction force is observed even after 10 seconds from the interruption of the applied voltage, there is a possibility that misregistration occurs upon removal of the workpiece.

After the measurement of an attraction force, specimens for resistivity measurement were separately cut out from a workpiece-adjoining region and an electrode-adjoining region of the insulating layer of each sample. A surface resistivity was then measured. The specimens had a thickness of 50 μm.

The measurement of surface resistivity was carried out according to the JIS test (K6911-1995, 5.13 resistivity). The tester used was Hirester IP MCP-HT260 (Dia Instruments Co., Ltd.) with a HRS probe. Using the specimens taken from a central portion of the wafer heating apparatus with an electrostatic attraction function, measurement was carried out in an environment at room temperature (25° C.) and a humidity of 50%.

Those samples in which the surface resistivity (ρsS) of the workpiece-adjoining region was lower than the surface resistivity (ρsE) of the electrode-adjoining region produced no residual attraction force, allowing the workpiece to be removed without misregistration. In contrast, those samples in which the surface resistivity (ρsS) of the workpiece-adjoining region was greater than the surface resistivity (ρsE) of the electrode-adjoining region produced a residual attraction force, allowing for misregistration upon removal of the workpiece.

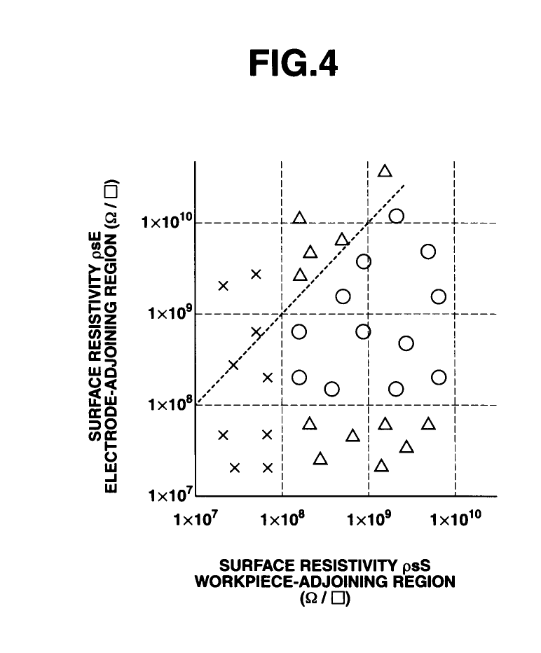

Provided that attraction performance is acceptable when an attraction force of at least 10 g/cm² is produced upon application of a DC voltage of ±500 V at room temperature (25° C.), 300° C. and 650° C., the results of Example are plotted in FIG. 4. In the area where a ratio (ρsE/ρsS) of the surface resistivity (ρsE) of the electrode-adjoining region to the surface resistivity (ρsS) of the workpiece-adjoining region of the insulating layer is up to 100, ρsE is at least 1×10⁹ Ω/square and ρsS is at least 1×10⁸ Ω/square, a high attraction force is produced without anomalous current leakage or breakdown. In other areas, sufficient attraction performance is not available due to a failure by breakdown or an attraction force of less than 10 g/cm².

It is noted that in FIG. 4, evaluation is based on the following criteria.

◯: attraction force ≦10 g/cm²

Δ: attraction force <10 g/cm²

X: substantial current leakage, breakdown

1. A wafer heating apparatus having a function of electrostatically attracting a workpiece, comprising a conductive heating layer formed on one surface of a support substrate, a conductive electrode for electrostatic attraction formed on another surface of the support substrate, and an insulating layer formed to cover the heating layer and the electrode for electrostatic attraction, characterized in that said insulating layer covering the electrode includes a region adjoining the electrode and another region disposed to adjoin the workpiece, and the workpiece-adjoining region has a surface resistivity (ρsS) lower than the surface resistivity (ρsE) of the electrode-adjoining region.

2. A wafer heating apparatus having a function of electrostatically attracting a workpiece, comprising a conductive heating layer formed on one surface of a support substrate, a conductive electrode for electrostatic attraction formed on another surface of the support substrate, and an insulating layer formed to cover the heating layer and the electrode for electrostatic attraction, characterized in that said insulating layer covering the electrode includes a region adjoining the electrode and another region disposed to adjoin the workpiece, that a ratio (ρsE/ρsS) of a surface resistivity (ρsE) of the electrode-adjoining region to a surface resistivity (ρsS) of the workpiece-adjoining region is up to 100, and that the surface resistivities (ρsE and ρsS) are each at least 1×10⁸ Ω/square.

3. A wafer heating apparatus having an electrostatic attraction function according to claim 1, wherein said insulating layer comprises at least one component selected from the group consisting of silicon nitride, boron nitride, aluminum nitride, alumina, a mixture of boron nitride and silicon nitride, a mixture of boron nitride and aluminum nitride, and yttria, and a resistivity modifier is incorporated in a range of 0.001% to 30% by weight for modifying the surface resistivity of the insulating layer.

4. A wafer heating apparatus having an electrostatic attraction function according to claim 3, wherein said resistivity modifier is at least one member selected from the group consisting of boron, silicon, carbon, aluminum, yttrium, titanium, and boron carbide.

5. A wafer heating apparatus having an electrostatic attraction function according to claim 1, wherein said support substrate comprises a main component selected from the group consisting of sintered silicon nitride, sintered boron nitride, a sintered mixture of boron nitride and aluminum nitride, sintered alumina, sintered aluminum nitride, pyrolytic boron nitride, and pyrolytic boron nitride-coated graphite.

6. A wafer heating apparatus having an electrostatic attraction function according to claim 1, wherein said electrode for electrostatic attraction has a bipolar structure having a pair of electrodes, the bipolar electrodes being alternately arranged in a comb-shaped or concentric fashion.

7. A wafer heating apparatus having an electrostatic attraction function according to claim 1, wherein at least one of said electrode for electrostatic attraction, said heating layer, and said insulating layer is formed by chemical vapor deposition.
